(19) United States
(12) Patent Application Publication
(10) Pub. No.: US 2026/0215592 A1
(43) Pub. Date: Jul. 30, 2026

(54) PATIENT SUPPORT APPARATUS WITH CPR FEATURES

(71) Applicant: Stryker Corporation, Portage, MI (US)

(72) Inventors: Anish Paul, Portage, MI (US); David Scharich, III, Coloma, MI (US); Krishna Sandeep Bhimavarapu, Kalamazoo, MI (US); Matthew Thomas Thielking, Schoolcraft, MI (US); James K. Galer, Byron Center, MI (US); Zane Marwan Shami, Kalamazoo, MI (US)

(21) Appl. No.: 19/143,723

(22) PCT Filed: Dec. 27, 2023
(86) PCT No.: PCT/US2023/085978

§ 371 Date: Jun. 26, 2025

Related U.S. Application Data
(60) Provisional application No. 63/435,777, filed on Dec. 28, 2022.

(51) Int. Cl. A47C 27/08; A61G 7/015; A61G 7/018; A61H 31/00

(52) U.S. Cl. CPC A47C 27/083; A61G 7/015; A61G 7/018; A61H 31/008; A61G 2203/30; A61H 2201/0103

(57) ABSTRACT

A patient support apparatus having a control system is provided that manages the delivery of electrical power to a CPR valve manifold actuator that opens or closes the CPR valve manifold. The control system may manage the power delivery process both when the patient support apparatus is operating on a bed-based DC power supply, such as a bed-based battery power supply, and/or when the patient support apparatus is plugged into an external source of electrical power, such as a conventional Alternating Current (AC) power outlet.

### BACKGROUND

The present disclosure relates to patient support apparatuses, such as beds, cots, stretchers, recliners, or the like. More specifically, the present disclosure relates to a patient support apparatus that includes an inflatable cushion and a deck for supporting a patient thereon and a CPR function where the deck of the patient support apparatus can be quickly flattened, and the inflatable cushion deflated to allow CPR to be administered to the patient supported thereon.

Existing patient support apparatuses, such as hospital beds, cots, and/or stretchers, typically each include a mattress, which is supported on a deck. The deck is often articulateable, such that the sections of the deck, for example the back section and/or leg section, can be raised or lowered for patient comfort. However, when the patient experiences a heart attack, in order to administer CPR, at least the patient's chest must be lying generally flat and, moreover, on a hard surface to administer CPR. Therefore, when the mattress is an inflatable mattress, in order to achieve the hard surface, the inflatable cushion must either be deflated to allow the patient to bottom out on the underlying deck or it must be inflated to a state where it no longer provides a cushioning function. When a patient experiences such an emergency, the faster the patient can receive CPR the better the outcome.

To flatten the deck, often the back section simply needs to be lowered. Other times, the leg section may need to be raised. This deck flattening function is typically achieved through controlling the actuators that normally raise or lower the back and leg sections. This is often achieved through a designated handle a CPR handle, which is located on the patient support apparatus adjacent the mattress. In some cases, the CPR handle releases the back section actuator via a cable and clutch arrangement, for example. To deflate the bladders, many beds employ a CPR valve manifold that has a plurality of air passageways that are each in fluid communication with one or more of the bladders so that the air can be exhausted from all the bladders through the manifold when the manifold air passageways are open to atmosphere. The CPR valve manifold is typically manually opened by a CPR strap, which extends from under the mattress to one side of the bed.

Therefore, the CPR process to flatten the bed and deflate the mattress typically requires two steps—pulling the CPR handle and then pulling the CPR strap. Further, with the manual opening of the CPR valve manifold, resetting the CPR valve manifold so that the mattress can be re-inflated after a CPR event has occurred, is also manual and therefore requires an additional step, again complicating the process.

For example, beds typically have an AC power connection to power the powered features on the bed. Some of the powered features, however, need to be operational even when there is a loss of AC power. To provide backup power, most beds have rechargeable DC batteries but they can get depleted, and there are certain features that must be able to operate when there is a loss of AC power and even when the DC battery may be depleted. CPR is one such feature. Hence, many beds do not rely on power to flatten the bed and empty the bladders during a CPR event and, instead, rely on a manual process, but as noted this process may require multiple steps during a time when time is scarce.

Accordingly, there is a need for simpler more efficient way to control the CPR valve manifold using power without reliance on AC power or the bed-based battery.

### SUMMARY

In its various forms, the present disclosure provides a patient support apparatus having a control system that manages the delivery of electrical power to a CPR valve manifold actuator that opens or closes the CPR valve manifold. The control system manages the power delivery process both when the patient support apparatus is operating on a bed-based DC power supply, such as a bed-based battery power supply, and/or when the patient support apparatus is plugged into an external source of electrical power, such as a conventional Alternating Current (AC) power outlet. The patient support apparatus includes an additional or second bed-based power supply, such as a second battery power supply, which is used by the control system to power the CPR valve manifold actuator to at least open the CPR valve manifold when the patient support apparatus does not have access to the external source power (e.g., the patient support apparatus is either unplugged from or there is a power outage at the AC power outlet). In this manner, when the AC power is unavailable, the control system rations the power to the CPR valve manifold by using the second bed-based power supply in a manner that reduces the impact on the main bed-based power supply all in a manner that is either invisible to the user or done so in a manner that reduces the impact on the user. While described in reference to powering a CPR valve manifold, the control system may be configured using similar or the same logic to power other electrical devices at the patient support apparatus.

In one form, a patient support apparatus includes a control system, a first electrical device, and a second electrical device. The control system is configured to electrically couple to a first DC power supply and configured to electrically couple to and disconnect from an AC power supply and to rely on the first DC power supply to power the first electrical device when disconnected from the AC power supply. The control system is further configured to electrically couple to a second DC power supply, and optionally includes a timer, and is configured to selectively power the second electrical device using the second DC power supply independent of the first DC power supply for a predetermined time period, for example based on the timer, when the control system is disconnected from the AC power supply.

In another form, a patient support apparatus includes a control system, a first electrical device, and a second electrical device. The control system includes a main controller that is electrically coupled to a first DC power supply and configured to electrically couple to and disconnect from an AC power supply and to rely on the first DC power supply to power the first electrical device when disconnected from the AC power supply. The control system further includes a second DC power supply. The control system is configured to selectively power the second electrical device using the second DC power supply independent of the main controller and the first DC power supply when the control system is disconnected from the AC power supply.

In any of the above, the control system includes a user input, and the control system is configured to selectively power the second electrical device using the second DC power supply based on the user input. For example, the user input may comprise a manually operable handle.

In another aspect, in any of the above, the control system includes a switch, and the control system is configured to selectively power the second electrical device using the second DC power supply when the switch is activated. For example, the switch may be actuated by a manually operable handle.

In another aspect, the control system includes a sensor, and the control system is configured to selectively power the second electrical device using the second DC power supply based on input from the sensor. For example, the sensor is configured to detect the position of a manually operable handle.

In any of the above, the second electrical device comprises an actuator. For example, the actuator may comprise a valve manifold actuator to open and/or close a valve manifold for an inflatable cushion supported on the patient support apparatus. For example, when using the timer, the timer has a predetermined time period approximately equal to the time it takes to open the valve manifold.

In any of the above, the second DC power supply comprises a battery or a capacitor.

In another form, a patient support apparatus includes an inflatable cushion formed from a plurality of inflatable bladders and a pneumatic system for controlling the pressure in the plurality of inflatable bladders. The pneumatic system includes a valve manifold in fluid communication with a group of (or all of) the inflatable bladders of the plurality of inflatable bladders. When opened, the valve manifold allows air to quickly exhaust from the inflatable bladders to, therefore, allow at least a portion of the inflatable cushion to deflate quickly. The patient support apparatus further includes a control system that is configured to electrically couple to a first DC power supply and is configured to electrically couple to and disconnect from an AC power supply and to rely on the first DC power supply when disconnected from the AC power supply. The control system further includes an electrical valve manifold actuator to selectively open the valve manifold and is configured to electrically couple to a second DC power supply, wherein the control system selectively powers the valve manifold actuator using the second DC power supply independent of the first DC power supply at least when the control system is disconnected from the AC power supply.

In one aspect, the control system includes a main controller that is powered by the AC power supply when the control system is electrically coupled to the AC power supply and is powered by the first DC power supply when disconnected from the AC power supply. The control system is configured to selectively power the second electrical device using the second DC power supply independent of the main controller and the first DC power supply when the control system is disconnected from the AC source.

In one aspect, the control system is configured to recharge the first and second DC power supplies when coupled to the AC power supply.

In one aspect, the control system includes a timer, with a predetermined time period, to selectively power the powered valve manifold actuator to open the valve manifold using the second DC power supply for the predetermined time period. For example, the control system may include a power circuit electrically coupled to the valve manifold actuator and to the second DC power supply, which includes the timer and a switch or a sensor as input to the power circuit. The power circuit powers the valve manifold actuator using the voltage from the second DC power supply for the predetermined time period of the timer based on the input from the switch or the sensor.

In one aspect, the power circuit includes a switch. For example, the switch may be actuated by a manually operable handle.

In a further aspect, the predetermined time period of the timer is approximately equal to the time it takes to fully open the valve manifold.

In yet another aspect, the valve manifold comprises a plurality of valves that are in fluid communication with the inflatable bladders, a manifold housing, and a cover operable to open the plurality of valves of the valve manifold to allow all the air from the inflatable bladders to exhaust through the manifold, wherein the powered valve manifold actuator is electrically coupled to the cover to selectively open the plurality of valves.

In a further aspect, the cover is pivotally mounted to the manifold housing.

In yet another aspect, the patient support apparatus includes a user interface in communication with said control system and the user interface operable to allow a caregiver to input a CPR reset signal to the control system, and the control system operable to power the powered valve manifold actuator to close the valve manifold in response to the CPR reset signal.

In yet a further aspect, the second DC power supply is a rechargeable power supply, and the control system is configured to recharge the second DC power supply. For example, the control system is configured to recharge the second DC power supply when electrically coupled to the AC power supply.

In any of the above, the patient support apparatus includes an articulatable deck and a manual input, such as the manually operable handle, to allow the deck to move to a flat configuration.

In another form, a patient support apparatus includes an articulatable deck with a pivotal back section and an inflatable cushion with a plurality of inflatable bladders. The patient support apparatus further includes a deck actuator to raise or lower the back section of the deck. The patient support apparatus also includes a control system for powering and controlling the deck actuator and a pneumatic system for inflating and/or deflating the inflatable bladders of the plurality of inflatable bladders. The pneumatic system includes a valve manifold to allow air to exhaust from the inflatable bladders of the plurality of inflatable bladders to allow the patient to be supported on the deck, which provides a rigid support surface. The valve manifold includes a valve manifold actuator selectively powered to open the valve manifold. The control system is configured to electrically couple to a first DC power supply and configured to electrically couple to and disconnect from an AC power supply and to use the first DC power supply when disconnected from the AC power supply The control system is further configured to electrically couple to a second dedicated DC power supply to selectively power the valve manifold actuator independent of the first DC power supply for a predetermined time period.

In one aspect, wherein the control system is configured to selectively power the valve manifold actuator using the second DC power supply independent of the first DC power supply when the control system is disconnected from the AC power supply.

In a further aspect, the patient support apparatus includes a manual input to selectively lower the back section and to provide input to the control system to selectively power the valve manifold actuator.

In yet another aspect, the manual input comprises a manually operable handle. For example, the manually operable handle may be mounted to the patient support apparatus adjacent the inflatable cushion and, further, adjacent the back section of the deck.

In a further aspect, the manually operable handle is mechanically coupled to a switch to activate the switch, with the control system providing power to the valve manifold actuator when the switch is activated.

In a further aspect, the control system includes a timer, which sets the predetermined time period, to selectively power the valve manifold actuator, for example, using the second DC power supply when the control system is disconnected from the AC power supply. For example, the control system may include a power circuit electrically coupled to the valve manifold actuator and to the second DC power supply, which includes the timer and a switch. When the switch is activated, the power circuit powers the valve manifold actuator using the second DC power supply when the control system is disconnected from the AC power supply for the predetermined time period of the timer.

In one aspect, the switch is normally open.

In a further aspect, the predetermined time period of the timer is approximately equal to the time it takes to open the valve manifold.

In yet another aspect, the valve manifold comprises a valve manifold with a plurality of valves, which are in fluid communication with the inflatable bladders of the plurality of inflatable bladders, a manifold housing, and a cover operable to open the plurality of valves of the valve manifold to allow all the air from the inflatable bladders of the plurality of inflatable bladders to exhaust through the manifold, wherein the valve manifold actuator is mechanically coupled to the cover, for example via a push pull cable, to selectively open the plurality of valves.

In a further aspect, the cover is pivotally mounted to the manifold housing.

In yet another aspect, the patient support apparatus includes a user interface in communication with the control system, and the user interface is operable to allow a caregiver to input a CPR reset signal to the control system, and the control system is operable to power the valve manifold actuator to close the valve manifold in response to the CPR reset signal.

In any of the above, the second DC power supply is a rechargeable power supply, and the control system is configured to recharge the second DC power supply, for example when the control system is electrically coupled to the AC power supply.

Before the various embodiments disclosed herein are explained in detail, it is to be understood that the claims are not to be limited to the details of operation or to the details of construction and the arrangement of the components set forth in the following description or illustrated in the drawings. The embodiments described herein are capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a perspective view of a patient support apparatus according to one embodiment of the disclosure;

FIG. 2 is a perspective view of a deck of the patient support apparatus with the mattress removed for clarity;

FIG. 3 is a schematic drawing of the patient support apparatus control system;

FIG. 3A is an enlarged view of the CPR valve manifold; and

FIG. 3B is an enlarged view of the CPR valve manifold actuator.

### DETAILED DESCRIPTION

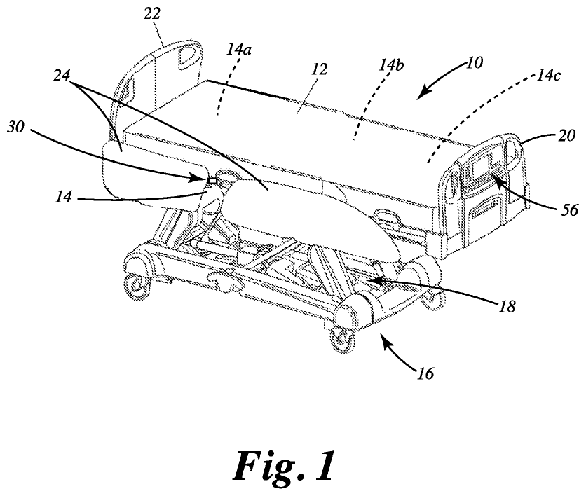

Referring to FIG. 1, the numeral 10 generally designates a patient support apparatus. Although the particular form of patient support apparatus 10 illustrated in FIG. 1 is a bed adapted for use in a hospital, or other medical setting, it will be understood that patient support apparatus 10 may be a cot, a stretcher, a gurney, a recliner, a residential bed, or any other structure capable of supporting a patient, whether stationary or mobile and/or whether used in a medical or residential setting.

In general, patient support apparatus 10 includes a mattress 12 that is supported on a litter deck 14, which in turn is supported on a litter frame 15. Litter deck 14 may have one or more articulatable deck sections, including a back deck section 14a (often referred to as a “Fowler”), a seat deck section 14b, and a thigh deck section 14c, and one or more deck actuators, including a back section deck actuator (FIG. 1), which together with the litter frame 15 are supported on a wheeled base 16 by a lift assembly 18.

Patient support apparatus 10 may further include one or more barriers, such as a footboard 20, a headboard 22, and a plurality of side rails 24, including head end side rails and foot end side rails. Side rails 24 are all shown in a lowered position in which ingress into, and egress out of, patient support apparatus 10 is not obstructed by the lowered side rails 24. Each side rail 24 is configured so it can be individually moved to a raised position, as well as to one or more intermediate positions.

Lift assembly 18 is adapted to raise and lower the litter frame 15 and litter deck 14 with respect to base 16 and may incorporate actuators, such as electric actuators, hydraulic actuators, pneumatic actuators, or any other suitable device for extending the lift assembly 18 for raising and lowering the litter frame 15 and litter deck 14. The actuators may be operated independently so that the litter frame 15 and litter deck 14 may be tilted (with respect to base 16), such as in a Trendelenburg orientation or in a reverse Trendelenburg orientation. The patient support apparatus 10 may also incorporate actuators, such as electric actuators, hydraulic actuators, pneumatic actuators, or any other suitable device, for moving the individual deck sections, such as the back section 14a. The back section 14a, which as noted may be referred to as the Fowler, is pivotable about a generally horizontal pivot axis between a flat or generally horizontal orientation (shown in FIG. 1) and a plurality of raised positions (not shown). The thigh deck section 14c (and optional foot deck section) may also be pivotable about generally horizontal pivot axes.

Mattress 12 includes one or more inflatable bladders to form an inflatable cushion 12a. Optionally, as noted below, inflatable cushion 12a may extend the full length and width of the mattress 12 or form only a portion of the mattress. Some of the inflatable bladders may form the main support surface under the patient, and others may form side bolsters, turning bladders or the like, and may be combined with a variety of different cushioning components, such as one or more gel layers and/or foam, including a foam crib. To inflate the various bladders, the patient support apparatus includes a pneumatic system, such as described below, which may be mostly contained in the mattress, including within the foot end of the mattress in a mattress control housing, such as disclosed in U.S. Pat. Nos. 5,542,136; 5,325,551; 8,910,334; 8,911,387; 7,406,736; 9,820,904; and 9,468,307, which are commonly owned by Stryker Corporation of Kalamazoo, Michigan, and are incorporated by referenced in their entireties herein. Alternately, the pneumatic system may be mounted in a modular housing mounted to the footboard.

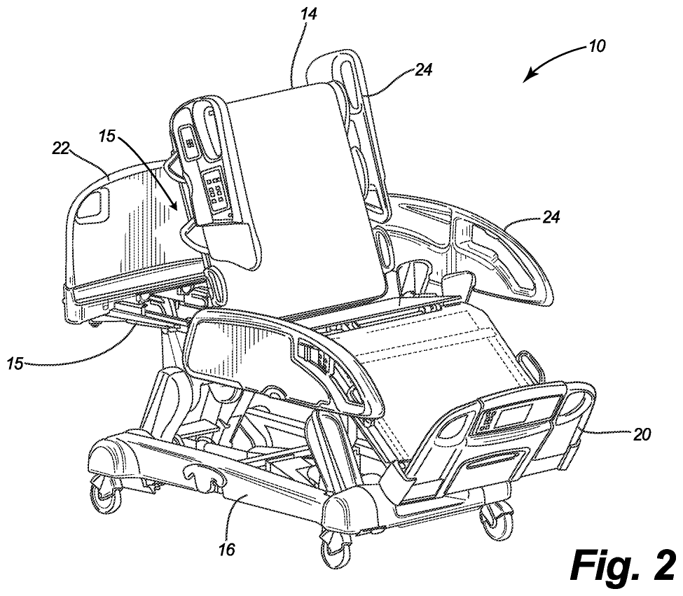

As noted above, the back section 14a of patient support apparatus 10 may be raised or lowered by a back section actuator (FIG. 1) to move the back section 14a from a generally flat position (e.g., horizontal position when the deck is horizontal, such as shown in FIG. 1) or a tilted or raised position (e.g., such as shown in FIG. 2). When the whole deck is flat and tilted, for example, when the foot end is lowered such as in the Trendelenburg position, or when the head is lowered such as when in the Trendelenburg position, the back section 14a may be flat and aligned with the other deck sections but may no longer be “horizontal” due to the tilt of the deck section, but would be aligned in a plane defined by the litter frame 15. When the patient, however, needs CPR to be administered, the protocol is to lower the Fowler quickly and then have a hard surface under the patient in order to administer CPR. Because CPR requires compression of a patient's chest, it is more easily and effectively accomplished while the patient's torso is lying flat and on a hard surface, rather than tilted upwardly at an angle. Further, because time is of the essence in emergency CPR situations, it is desirable for the bed to be easily and promptly adjusted so that the patient's torso moves quickly to the horizontal orientation,

To lower the back section 14a quickly, the back section actuator may be driven to move at higher speed that when normally raising the back section 14a to quickly lower the back section 14a, for example, by directing more current to the actuator motor, such as described in U.S. Pat. No. 8,006,332, or by declutching the actuator, such as described in U.S. Pat. No. 9,539,156, and optionally controlling the fall of the back section 14a via a spring, with the referenced patents commonly owned by Stryker Corporation of Kalamazoo, Michigan, and each incorporated by reference in its entirety herein.

The input to control the back section 14a during a CPR event may be at a designated CPR user input, such as a manually operable mechanical input 30, for example a CPR handle or pedal at the side of the deck (see FIG. 1), or may be an electronic input generated by a button provided, for example, at a user interface 56 such as at a user control module mounted to the footboard 20 or at another location.

For example, when using a handle, such CPR handle or pedal, the handle may include a cable that is mechanically coupled to the back section actuator to release the back section actuator or include an electrical link (electrical wiring with a switch) (see U.S. Pat. No. 7,836,531, which is commonly owned by Stryker Corporation of Kalamazoo, Michigan, and incorporated by referenced in its entirety herein) so that the Fowler lowers in a controlled, but rapid manner. The term “coupled” is used broadly herein to mean connected, either mechanically or electrically or pneumatically, although not necessarily directly. Further, two items that are “coupled” may also be integral with each other.

To provide a rigid surface under the patient and when the mattress includes an inflatable cushion formed from a plurality of bladders, the bladders can be either inflated to a max inflate condition (where the bladders are inflated to a maximum pressure such that the bladders are in effect relatively rigid) or deflated so the person bottoms out on the underlying deck. Hereinafter the description of the patient support apparatus will be made in the context of the mattress at least having one inflatable cushion under the patient's torso, which is deflated to allow the patient to be supported on the more rigid surface of the deck for administering CPR.

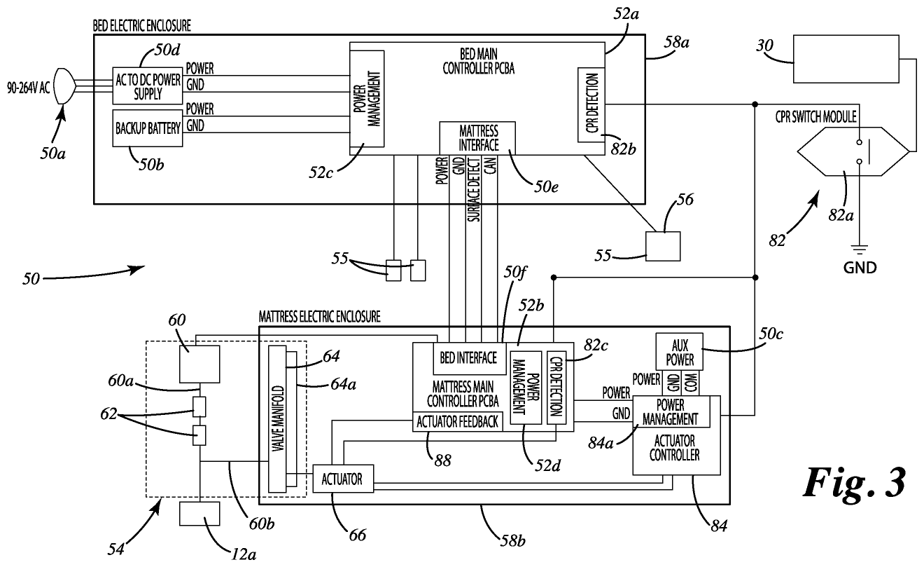

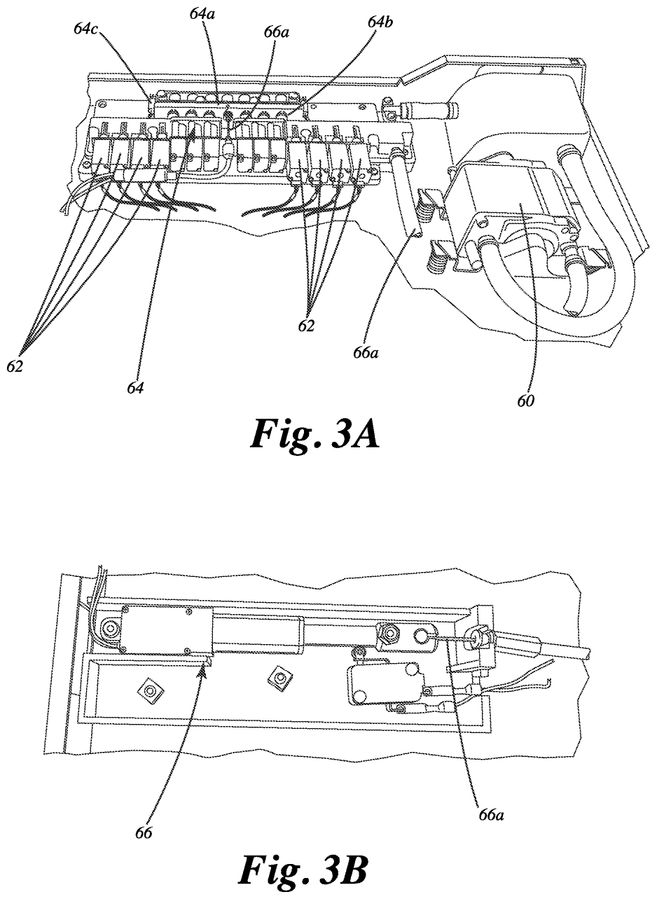

Referring to FIG. 3, patient support apparatus 10 includes a control system 50 to control the actuators and other electrical devices, such as other components or accessories of the patient support apparatus. As noted, control system 50 is configured to use power from an AC power supply 50a, when electrically coupled to the AC power supply, such as a wall outlet via a power cable, or use power from a main or first onboard DC power supply 50b, such as a battery, when disconnected from the AC power supply. The battery may take on any of a variety of different suitable forms, depending upon the particular implementation of patient support apparatus 10 and the functions that are to be carried out by control system 50. In some embodiments the battery is a lead-acid battery, while in other embodiments the battery is any one of a lithium-ion battery, a nickel-cadmium battery, a nickel-metal hydride battery, a nickel-zinc battery, or still other types of batteries. In most embodiments, the battery is rechargeable, but this is not necessarily the case in all embodiments.

As will be more fully described below, control system 50 of patient support apparatus 10 also includes a second or auxiliary onboard DC power supply 50c, which is used as a designated power supply for one or more of the electrical devices on the patient support apparatus, for example, for a predefined period of time. Auxiliary onboard DC power supply 50c may also comprise a battery, including a rechargeable battery, but may also comprise a capacitor. For example, the first onboard DC power supply 50b may have a voltage in a range of about 22 to 28 volts, and the second onboard DC power supply 50c may have a voltage in a range of about 10 to 18 volts. Therefore, the second onboard DC power supply 50c provides a lower voltage than the first onboard DC power supply.

Control system 50 may have one or more controllers (PCBA) to control various control and communication functions at the patient support apparatus 10. For example, a patient support apparatus 10 may have a main controller 52a and a mattress controller 52b. For example, main controller 52a may be configured for controlling and managing the patient support apparatus functions, such as controlling the movement of the deck sections, patient support apparatus exit functions, protocol reminders, alert functions (e.g., status of the various patient support apparatus functions, such as brakes), and for managing input from various user interfaces. The mattress controller 52b may be used for controlling the mattress functions, such as controlling the pneumatic system for supplying air to the mattress bladder or bladders and for controlling the CPR valve manifold actuator.

As will be more fully described below, the control system 50 is configured to selectively power an electrical device, such as the CPR valve manifold actuator described below, using second onboard DC power supply 50c independent of the main or first onboard DC power supply 50b, as well as independently of the main controller 52a noted below, for a predetermined period of time when the control system 50 is disconnected from the external AC power supply. In this manner, even when the patient support apparatus-based battery (e.g., first onboard DC power supply) is fully depleted and the patient support apparatus is disconnected from the external AC power supply (e.g., the wall AC power outlet) or the external AC power supply is not available (for example, due to a power outage), the electrical device, such as the CPR valve manifold actuator for the CPR valve manifold, can be operated using the second onboard DC power supply 50c. Thus, when employed to open the CPR valve manifold, the air can be quickly discharged from the inflatable bladder or bladders. It should be understood that optionally a manual, non-powered CPR release may also be provided, such as the strap described above, for example, in the event of total power failure.

Optionally, when the control system 50 is electrically coupled to the external AC power supply, the control system 50 is configured to selectively power the one electrical device using the AC power supply or using the first onboard DC power supply and, further, when using the AC power supply configured to recharge one or both onboard power supplies.

Referring again to FIG. 3, as noted, control system 50 includes a main controller 52a and mattress controller 52b. Main controller 52a is coupled to first onboard DC power supply 50b and includes an AC/DC power conversion circuit 50d for coupling external AC power supply 50a, as noted above. Additionally, main controller 52a includes a power management circuit 52c to manage the power coming from external AC power supply 50a and first onboard DC power supply 50b. For example, power management circuit 52c, along with main controller 52a, may be configured as described in co-pending U.S. patent application Ser. No. 16/828,323, entitled PATIENT CARE SYSTEM WITH POWER MANAGEMENT, filed on Mar. 24, 2020, and published as U.S. Publication 2020/0306115 on Oct. 1, 2020, which is commonly owned by Stryker Corporation of Kalamazoo, Michigan, and is incorporated by reference herein in its entirety.

Further, as noted above, main controller 52a is in communication with and powers, controls, and/or receives input from a plurality of electrical devices 55 at the patient support apparatus, such as the deck actuators, the caster brakes (e.g., when the caster brakes can be electrically actuated), user input interfaces, such as a user interface module 56, alert lights, a patient support apparatus exit system, and sensors that are used to sense the condition/status of components of the patient support apparatus 10. User interface module 56 allows a caregiver to control functions at the patient support apparatus, including, for example, deck height, deck orientation, caster brakes, mattress functions, and a patient support apparatus exit system, and other components and functions that may be provided at patient support apparatus 10.

Mattress controller 52b is in communication with main controller 52a via interfaces 50e and 50f and receives power and input from main controller 52a via, for example, wiring and a network, such as a CAN network, to power and control the components of the mattress, such as pneumatic system 54, described below. Mattress controller 52b may communicate with main controller 52a, for example, to provide feedback on the mattress, such as the pressure in the bladder or bladders, and other sensed conditions at the mattress, as well as the CPR function described below.

Each controller 52a, 52b may be constructed of any electrical component, or group of electrical components, that are capable of carrying out the functions described herein. In many embodiments, controllers 52a, 52b are each conventional microcontrollers, although not all such embodiments need include a microcontroller. In general, controllers 52a, 52b include any one or more microprocessors, microcontrollers, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. The instructions followed by and/or circuitry used by controllers 52a, 52b to carry out the functions described herein, including the power management functions, as well as any data necessary for carrying out these functions, are stored in memory (not labeled) or provided in modules, such as power management modules 52c, 52d accessible to controllers 52a, 52b. Further, each controller may be housed in an enclosure 58a (main controller housing), 58b (mattress controller housing), and co-located (in the same location) or located in different locations. For example, the main controller enclosure 58a may be located on the deck, such as in the foot end of the deck, while the mattress controller enclosure 58b may be located in the mattress.

To control the pressure in the bladder or bladders forming the inflatable cushion 12a of the mattress 12, the patient support apparatus includes a pneumatic system 54. Optionally, as noted, the inflatable cushion 12a may extend the full length of the mattress or may be combined with other cushions, such as a foam or gel cushion or cushions, for example, to provide support for the patient's legs and/or feet. Inflatable cushion 12a may also extend the full width of the mattress or may be supported on a foam crib, which may form side bolsters on the opposed sides of the inflatable cushion. Therefore, the number and arrangement of the inflatable bladders may vary. For examples of suitable inflatable bladder arrangements, reference is made to U.S. Pat. Nos. 8,856,992; 9,468,307; 10,682,273; and 10,987,265 which are commonly owned by Stryker Corporation of Kalamazoo, Michigan, and are incorporated by referenced in their entireties herein.

Referring again to FIG. 3, pneumatic system 54 includes an electrical pump 60 and one or more conduits 60a (such as tubing) that pneumatically couple the pump output to the bladder or bladders of the inflatable cushion 12a via a plurality of valves 62, such as electrical solenoid valves. Pump 60 and valves 62 are controlled by control system 50, such as by mattress controller 52b, to control the pressure in the inflatable bladders.

As noted above, in an emergency situation, it may be desired to quickly deflate the bladder or bladders in the inflatable cushion, which are under the patient so the patient bottoms out onto the deck and is supported by the deck's rigid surface. Once supported on the deck, CPR may be administered to the patient. To deflate the bladder(s) quickly, pneumatic system 54 includes a valve manifold 64 that is in fluid communication with the bladder(s) via conduit or conduits 60a via one or more conduits 60b between the flow from valves 62 and the respective bladders.

Referring to FIG. 3A, valve manifold 64 includes a housing 64a with a plurality of isolated chambers that are in fluid communication respectively with each bladder (via the respective conduit supplying air to the bladder from valves 62) and a cover 64b that keeps the chambers sealed when it is in a closed position. When the cover 64b is moved to an open position, the cover opens all the chambers allowing the air from all the respective bladders to deflate or dump air through the manifold.

In one form, the cover 64b is a pivotally mounted cover and biased in its closed position by one or more springs 64c (FIG. 3A). In this manner, when cover 64b is pulled about its pivot axis, cover 64b will move to its open position and thereby open the valve manifold.

It should be understood the number of valves and the number and path of conduits 60a and 60b may vary as needed. For ease of illustration, FIG. 3 only illustrates one of each conduit 60a, 62a. It should be understood the number of inflatable bladders and their arrangement may vary too, and further may be arranged in groups, such as zones for supporting specific areas of the patient's body.

To open valve manifold 64, patient support apparatus 10 includes a powered CPR valve manifold actuator 66. Referring to FIG. 3B, valve manifold actuator 66 may comprise a linear actuator, such as is available from Linac. Valve manifold actuator 66 is coupled to the cover 64b (such as shown in FIG. 3A) optionally via a flexible link 66a, such as a push pull cable. In this manner, when valve manifold actuator 66 is contracted the link will pull on the cover 64b and open the CPR valve manifold. Similarly, when the valve manifold actuator 66 is extended the link will push on the cover 64b and close the CPR valve manifold 64 with the assistance of optional springs 64c noted above. It should be understood cover 64b may be configured to translate, such as by sliding, instead of pivoting to open or close the CPR valve manifold.

To manage the power consumption on patient support apparatus 10 and, more importantly, to make sure power is available when the patient support apparatus is not electrically coupled to (or is disconnected from) the external AC power supply, e.g., wall inlet power, as noted, and even when the first onboard DC power supply 50a is fully depleted, as noted, patient support apparatus 10 includes second onboard DC power supply 50c to power valve manifold actuator 66 and open valve manifold 64. To power valve manifold actuator 66 and to power valve manifold actuator 66 at least for the needed duration (e.g., long enough to open the valve manifold), control system 50, such as actuator controller 84, optionally includes a timer. The timer may be an electronic timer electrically coupled between the second onboard DC power supply and the valve manifold actuator 66 or may be a timer logic circuit incorporated into actuator controller 84 or any of the controllers, for example. Further, as will be more fully described below, control system 50 selectively powers the valve manifold actuator 66 based on an input, such an input from a user.

The timer may be a timer circuit, such as an RC circuit, or may be an integrated circuit board, such as an auto lock relay cycle timer time delay switch module commercially available from Texas Instruments or Analog Devices, or may be a programmable logic circuit (PLC), which is configured to operate and provide power to the valve manifold actuator 66 over a predetermined time period. For example, the predetermined time period is sufficient to allow the valve manifold actuator 66 to open the valve manifold 64, and optionally close the manifold. A suitable time period may be 1-8 seconds, or 2-7 seconds, or about 5-6 seconds. As will be more fully described below, the power management logic may be configured to power valve manifold actuator 66 to close the CPR valve manifold 64 only when the external AC power supply is coupled to the patient support apparatus 10 via main controller 52a. As will be more fully described below, the timer may also be used when closing the CPR valve manifold.

Referring again to FIG. 3, to trigger the timer, as noted, control system 50 includes an input, such as a user input, to initiate the timer to power the valve manifold actuator 66. For example, in one form, as shown in FIG. 1, patient support apparatus 10 optionally includes a manually operable mechanical input 30, such as manually operable handle 30a, which may be mounted to the patient support apparatus adjacent the mattress 12. For example, manually operable mechanical input 30 may be located adjacent the inflatable cushion, and further adjacent the back section 14a of the deck. As noted above, manually operable mechanical input 30 may comprise a handle 30a (FIG. 1) that is also configured to lower the Fowler, for example, using the methods described above. In this manner, a user, such as a caregiver, can use a single touch point to lower the Fowler (and optionally flatten the entire deck) and deflate the inflatable cushion, which can save time and attention.

When a caregiver activates the CPR function, such as by manually operating a manually operable input 30, such as by pulling on handle 30a, the control system 50 is configured to selectively power the valve manifold actuator 66 for the predetermined time period, for example as measured by the timer, using the second onboard DC power supply independent of the first onboard DC power supply, as well as main controller 52, at least when the control system is disconnected from the AC power supply. For example, control system 50 may include a switch or a sensor 82, which is activated when the handle has been pulled. The switch or sensor 82 may be used as input to control system 50 to open the valve manifold and deflate the inflatable cushion.

In the illustrated embodiment, the sensor or switch 82 comprises a switch 82a that is activated when the handle is pulled. For example, the switch 82a has a normally open state (where no current can pass through) and when activated closes so that current can pass through the switch to ground to provide input to control system 50. Switch 82a may provide input to CPR detection circuits or logic 82b and 82c provided in controllers 52a, 52b, as well as input to an actuator controller 84 described below. Thus, switch 82a may be used as an input and trigger the control system 50 to initiate the time period and allow the control system 50 to pass the current from the second DC voltage supply to the valve manifold actuator 66 for the predetermined time period (as measured by the timer), sufficient to move the valve manifold cover 64b to its open position and open the CPR valve manifold 64. When pulled, therefore, the control system 50 (e.g., via controller 84) then powers the valve manifold actuator 66 to contract and open the CPR valve manifold 64 using the second onboard DC power supply 50c for the predetermined time period (as measured by the timer), independent of the first onboard DC power supply 50b when the control system 50 is disconnected from the AC power supply 50a.

When control system 50 is electrically coupled to the external AC power supply 50a, control system 50 may be configured via its power management circuits (e.g., power management circuits 52c, 52d) to override the second onboard DC power supply and use the external AC supply power to power the valve manifold actuator 66 to open or close the valve manifold. Alternately, control system 50 may be configured via its power management circuits (e.g., power management circuits 52c, 52d) to override the second onboard DC power supply and use the first onboard DC supply power 50b to power the valve manifold actuator 66 when control system 50 is electrically coupled to the external AC power supply 50a. Though in most forms the first onboard DC supply power 50b may only be used as a backup battery for when there is no external AC power to power other electrical components at the patient support apparatus.

Optionally, control system 50 may be configured to detect the state of actuator 66—for example, when the actuator is extended or contracted—for example, through one or more sensors at actuator 66. Input from these sensors may be provided to an actuator feedback circuit 88 included in mattress controller 52b.

In one form, referring again to FIG. 3, as noted above, control system 50 may include a dedicated actuator controller 84 to power the valve manifold actuator 66 with its own power management circuit 84a. For example, dedicated power management circuit 84a that is in communication with and powered by mattress controller 52b and is electrically coupled to the valve manifold actuator 66 and to second onboard DC power supply 50c to power and control valve manifold actuator 66 based either on instructions from the mattress controller and/or its own power management circuit 84a. Dedicated power management circuit 84a may include the timer logic circuit and may also receive input from switch 82a. Thus, when handle 30a is pulled, the switch 82a closes to provide input that triggers the control system via actuator controller 84 to deliver power to the valve manifold actuator 66 for the predetermined time period as measured by the timer. The power source is then determined by any one or more of the power management circuits 52c, 52d, and/or 84a. In one aspect, actuator controller 84a may be configured such that its primary function is to detect that power present is from mattress controller 52b. When power is not preset from the mattress controller 52b, it will then start pulling power from second onboard DC power supply 50c. Actuator controller 84a may also be configured to detect the power level of second onboard DC power supply 50c and recharge the second onboard DC power supply 50c when it detects that the level falls below a threshold level of power.

As noted above, when control system 50 is electrically coupled to the external AC power supply 50a, control system 50 is configured to selectively power the valve manifold actuator 66 using the external AC power supply when the switch is activated, effectively bypassing second onboard DC power supply 50c using, for example, an OR gate in main controller 52a.

As noted, a sensor may be used as input to the timer, which senses the position of handle 30a instead. In either case, the sensor or switch acts as a trigger to start the timer, which allows current to flow to the valve manifold actuator 66.

As noted above, the valve manifold 64 is in fluid communication with the bladders via one or more conduits with fluid delivery to the bladders via the valve manifold. It should be understood that valve manifold 64, when opened, opens the fluid communication with optionally all the bladders, including any turn bladders and side bolster bladders. Thus, the entire inflated portion of the mattress can be quickly deflated through the CPR valve manifold 64. As described above, valve manifold actuator 66 may be mechanically coupled to the cover 64b via a link, such as a push pull cable, which is mechanically coupled to the valve manifold actuator 66 on one end and mechanically coupled to the cover 64b on the other end so that when it is contracted, the link pulls on the cover to open the manifold valve. Alternately, the valve manifold actuator 66 may be located in close proximity to valve manifold 64 so that it can directly mechanically couple to the cover 64b. To close the manifold, as noted below, actuator 66, is contracted or extended to pull or push on the cover to open or close the valve manifold 64 for a predefined period of time.

In yet another aspect, as noted, the patient support apparatus 10 includes user interface module 56 that is in communication with the control system 50 and is operable to allow a caregiver to input a CPR reset signal to the control system. The control system 50 is operable to power the valve manifold actuator 66 to close the valve manifold in response to the CPR reset signal. Hence in one aspect, the CPR valve manifold 64 may only be closed in response to the reset input when the patient support apparatus is coupled to the AC power supply (and when the AC power is available). Hence the second onboard DC power supply may be configured to be used only to open the manifold. However, it should be understood the second onboard DC power supply may also be configured to power the actuator to close the valve manifold.

For example, the user interface module may include buttons and/or a touch screen user interface to allow a caregiver to control the patient support apparatus 10 and, further, input a CPR reset signal after CPR has been completed so that the control system receives input to re-inflate the inflatable bladders. For an example of a suitable CPR reset interface is described in U.S. patent application Ser. No. 16/691,062, filed on Nov. 21, 2019, and published as U.S. Publication 2020/0163818 on May 28, 2020, which is commonly owned by Stryker Corporation of Kalamazoo, Michigan, and incorporated by referenced in its entirety herein.

Optionally, the second onboard DC power supply is also a rechargeable power supply. Referring to FIG. 3, control system 50 is in electrical communication with second onboard DC power supply 50c and is configured to recharge the second onboard DC power supply 50c. For example, the control system 50 may be configured to recharge the second onboard DC power supply 50c via power management circuit 84a automatically or when the power level is detected below the power level threshold, noted above, when controller 52a is electrically coupled to the AC power supply.

As noted above, user interface module 56 allows a user to select a CPR reset input, such as at a touch screen, which generates a signal and input to the main controller 52. Based on the reset input, and using the timer logic main controller 52a allows power from the external AC power supply (when electrically coupled to the AC power supply) to actuate the valve manifold actuator 66 (e.g., to cause the actuator to extend) to close the valve manifold 64. Alternately, main controller 52a, as noted, may be configured to allow power from the first onboard DC power supply (when not electrically coupled to the AC power supply) to power the actuator via controllers 52b and 84 to close the valve manifold. The main controller may be configured to power only the valve manifold actuator 66 to close the valve manifold using the AC power.

Once the manifold valve is closed, main controller 52a is configured to send instructions to mattress controller 52b to re-inflate the bladder(s). To extend the valve manifold actuator 66, actuator controller 84 reverses the polarity of the applied voltage to the valve manifold actuator 66. Optionally, control system 50, such as via actuator controller 84, is configured to power the valve manifold actuator 66 to close the valve manifold using the timer logic.

It will be understood by those skilled in the art that patient support apparatus 10 can be designed with other types of mechanical constructions, such as, but not limited to, that described in commonly assigned, U.S. Pat. No. 10,130,536 issued to Roussy et al., entitled PATIENT SUPPORT USABLE WITH BARIATRIC PATIENTS, which is commonly owned by Stryker Corporation of Kalamazoo, Michigan, the complete disclosure of which is incorporated herein by reference in its entirety herein. In another embodiment, the mechanical construction of patient support apparatus 10 may be the same as, or nearly the same as, the mechanical construction of the Model 3002 S3 bed manufactured and sold by Stryker Corporation of Kalamazoo, Michigan. This mechanical construction is described in greater detail in the Stryker Maintenance Manual for the MedSurg Bed, Model 3002 S3, published in 2010 by Stryker Corporation of Kalamazoo, Michigan, the complete disclosure of which is incorporated herein by reference. It will be understood by those skilled in the art that patient support apparatus 10 can be designed with still other types of mechanical constructions, such as, but not limited to, those described in commonly assigned, U.S. Pat. No. 7,690,059 issued to Lemire et al., and entitled HOSPITAL BED; and/or commonly assigned U.S. Patent Publication No. 2007/0163045 filed by Becker et al., and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosures of both of which are also hereby incorporated herein by reference. The mechanical construction of patient support apparatus 10 may also take on still other forms different from what is disclosed in the aforementioned references.

The patient support apparatus 10 may also incorporate an exit detection function, as noted, that is adapted to issue an alert when a patient exits from patient support apparatus 10. Such an exit detection function may include any of the same features and/or functions as, and/or may be constructed in any of the same manners as, the exit detection systems disclosed in commonly assigned U.S. Patent Application No. 62/889,254 filed Aug. 20, 2019, by inventors Sujay Sukumaran et al., and entitled PERSON SUPPORT APPARATUS WITH ADJUSTABLE EXIT DETECTION ZONES; U.S. patent application Ser. No. 17/318,476 filed May 12, 2021, by inventors Sujay Sukumaran et al., and entitled PATIENT SUPPORT APPARATUS WITH AUTOMATIC EXIT DETECTION MODES OF OPERATION; and/or the exit detection system disclosed in commonly assigned U.S. Pat. No. 5,276,432 issued to Travis and entitled PATIENT EXIT DETECTION MECHANISM FOR HOSPITAL BED, the complete disclosures of all of which are incorporated herein by reference in their entireties.

Further details of one type of monitoring system that may be built into patient support apparatus 10 are disclosed in commonly assigned U.S. Patent Application No. 62/864,638 filed Jun. 21, 2019, by inventors Kurosh Nahavandi et al., and entitled PATIENT SUPPORT APPARATUS WITH CAREGIVER REMINDERS, as well as commonly assigned U.S. patent application Ser. No. 16/721,133 filed Dec. 19, 2019, by inventors Kurosh Nahavandi et al., and entitled PATIENT SUPPORT APPARATUSES WITH MOTION CUSTOMIZATION, the complete disclosures of both of which are incorporated herein by reference in their entireties. Other types of monitoring systems may be included within patient support apparatus 10 for monitoring parameters of the patient support apparatus 10.

In some embodiments, patient support apparatus 10 may incorporate a scale system that may include any of the same features, components, and/or functions as the scale systems disclosed in the following commonly assigned patent references: U.S. Patent Application No. 62/889,254 filed Aug. 20, 2019, by inventors Sujay Sukumaran et al. and entitled PERSON SUPPORT APPARATUS WITH ADJUSTABLE EXIT DETECTION ZONES; U.S. Patent Application No. 63/255,211 filed Oct. 13, 2021, by inventors Sujay Sukumaran et al., and entitled PATIENT SUPPORT APPPARATUS WITH AUTOMATIC SCALE FUNCTIONALITY; U.S. Pat. No. 10,357,185 issued to Marko Kostic et al. on Jul. 23, 2019, and entitled PERSON SUPPORT APPARATUSES WITH MOTION MONITORING; U.S. Patent No. 11,33,233 issued to Michael Hayes et al. on Jun. 15, 2021, and entitled PATIENT SUPPORT APPARATUS WITH PATIENT INFORMATION SENSORS; U.S. patent application Ser. No. 16/992,515 filed Aug. 13, 2020, by inventors Kurosh Nahavandi et al. and entitled PATIENT SUPPORT APPARATUS WITH EQUIPMENT WEIGHT LOG; and U.S. Patent Application No. 63/255,223, filed Oct. 13, 2021, by inventors Sujay Sukumaran et al., and entitled PATIENT SUPPORT APPARATUS WITH PATIENT WEIGHT MONITORING, the complete disclosures of all of which are incorporated herein by reference in their entireties. The scale system may utilize the same force sensors that are utilized by the exit detection system, in some embodiments, or it may utilize one or more different sensors.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

1. A patient support apparatus comprising:
a control system;
a first electrical device;
a second electrical device, wherein the control system is configured to electrically couple to a first DC power supply and is configured to electrically couple to and disconnect from an AC power supply and to rely on the first DC power supply to power the first electrical device when disconnected from the AC power supply; and
wherein the control system is configured to electrically couple to a second DC power supply, the control system being configured to selectively power the second electrical device using the second DC power supply independent of the first DC power supply when the control system is disconnected from the AC power supply.

2. The patient support apparatus of claim 1 wherein
the control system being configured to selectively power the second electrical device using the second DC power supply independent of the controller and the first DC power supply when the control system is disconnected from the AC source.

3. The patient support apparatus according to claim 1, wherein the control system includes a user input, and the control system is configured to selectively power the second electrical device using the second DC power supply based on the user input, and wherein the user input comprises a manually operable handle.

4. (canceled)

5. The patient support apparatus according to claim 1, wherein the control system includes a switch, and the control system is configured to selectively power the second electrical device using the second DC power supply when the switch is activated, and further comprising a manually operable handle to actuate the switch.

6. (canceled)

7. The patient support apparatus according to claim 1, wherein the control system includes a sensor, and the control system is configured to selectively power the second electrical device using the second DC power supply based on input from the sensor, and wherein the sensor is configured to detect the position of a manually operable handle.

8. (canceled)

9. The patient support apparatus according to claim 1 wherein the second electrical device comprises an actuator, and further comprising a valve manifold and an inflatable cushion supported on the patient support apparatus, the valve manifold controlling fluid communication with the inflatable cushion, and the actuator comprises a valve manifold actuator to open and/or close the valve manifold.

10. (canceled)

11. The patient support apparatus according to claim 1, wherein the control system is configured to selectively power the second electrical device using the second DC power supply independent the first DC power supply when the control system is disconnected from the AC source based on a parameter.

12. The patient support apparatus according to claim 11, further comprising a timer, the timer having a predetermined time period approximately equal to the time it takes to open the valve manifold, the predetermined time providing the parameter, and the control system being configured to selectively power the second electrical device using the second DC power supply independent of the first DC power supply when the control system is disconnected from the AC source based on the predetermined time period.

13. A patient support apparatus comprising:
an inflatable cushion formed from a plurality of inflatable bladders;
a pneumatic system for controlling the pressure in the plurality of inflatable bladders, the pneumatic system including a valve manifold in fluid communication with the plurality of inflatable bladders, wherein, when opened, the valve manifold allows air to quickly exhaust from the plurality of inflatable bladders to allow the inflatable cushion to deflate quickly; and
a control system configured to electrically couple to a first DC power supply and to electrically couple to and disconnect from an AC power supply and further to rely on the first DC power supply when disconnected from the AC power supply, the control system further including an electrical actuator to selectively open the valve manifold, the control system configured to electrically couple a second DC power supply wherein the control system selectively powers the valve manifold actuator using the second DC power supply independent of the first DC power supply at least when the control system is disconnected from the AC power supply.

14. The patient support apparatus according to claim 13, wherein the control system includes a controller powered by the AC power supply when the control system is electrically coupled to the AC power supply and is powered by the first DC power supply when disconnected from the AC power supply, the control system is configured to selectively power the second electrical device using the second DC power supply independent of the controller and the first DC power supply when the control system is disconnected from the AC source.

15. The patient support apparatus according to claim 13, wherein:
the control system is configured to recharge the first and second DC power supplies when coupled to the AC power supply; and
the control system includes a timer having a predetermined time period to selectively power the powered valve manifold actuator to open the valve manifold using the second DC power supply for the predetermined time period.

16. (canceled)

17. The patient support apparatus according to claim 15, wherein the control system includes a power circuit coupled to the valve manifold actuator and to the second DC power supply, the power circuit including the timer and a switch or a sensor as input to the power circuit, with the power circuit powering the valve manifold actuator using the voltage from the second DC power supply for the predetermined time period of the timer based on the input from the switch or the sensor, wherein the power circuit includes a switch actuated by a manually operable handle.

18. (canceled)

19. The patient support apparatus according to claim 15, wherein the predetermined time period of the timer is approximately equal to the time it takes to fully open the valve manifold.

20. The patient support apparatus according to claim 13, wherein:
the valve manifold comprises a plurality of chambers, each chamber in fluid communication with at least one inflatable bladder of the plurality of inflatable bladders, a manifold housing, and a cover operable to open the plurality of chambers of the valve manifold to allow the air from the inflatable bladders to exhaust through the manifold, and wherein the powered valve manifold actuator is mechanically coupled to the cover to selectively open the plurality of valves;
the control system is configured to power the valve manifold actuator to close the valve manifold in response to an input;
the input is selected from a group of inputs consisting of a predetermined time period, a reset signal, a mechanical release, and pressure/quantity of air released by the manifold.

21. (canceled)

22. The patient support apparatus according to claim 13, further comprising a user interface in communication with said control system and the user interface operable to allow a caregiver to input a CPR reset signal to the control system, and the control system operable to power the powered valve manifold actuator to close the valve manifold in response to the CPR reset signal.

23. The patient support apparatus according to claim 1, further comprising an articulatable deck and a manual input, such as the manually operable handle, to allow the deck to move to a flat configuration.

24. A patient support apparatus comprising:
an articulatable deck with a pivotal back section;
an inflatable cushion formed from a plurality of inflatable bladders;
a deck actuator to raise or lower the back section of the deck;
a control system for powering and controlling the deck actuator;
a pneumatic system for inflating and/or deflating the inflatable bladders of the plurality of inflatable bladders, the pneumatic system including a valve manifold to allow air to exhaust from the inflatable bladders of the plurality of inflatable bladders to allow the patient to be supported on the deck, and the valve manifold including a valve manifold actuator selectively powered to open the valve manifold; and
wherein the control system is configured to electrically couple to a first DC power supply and is configured to electrically couple to and disconnect from an AC power supply and to use the first DC power supply when disconnected from the AC power supply, and the control system being further configured to electrically couple to a second dedicated DC power supply to selectively power the valve manifold actuator independent of the first DC power supply for a predetermined time period.

25. The patient support apparatus according to claim 24, wherein:
the patient support apparatus includes a manual input to selectively lower the back section and to provide input to the control system to selectively power the valve manifold actuator;
the manual input comprises a manually operable handle, the manually operable handle being mounted to the patient support apparatus adjacent the inflatable cushion and, further, adjacent the back section of the deck; and
the manually operable handle being coupled to a switch to activate the switch, with the control system providing power to the valve manifold actuator when the switch is activated by the manually operable handle.

26. (canceled)

27. (canceled)

28. The patient support apparatus according to claim 24, wherein:
the control system includes a timer setting the predetermined time period, and the timer is configured to selectively power the valve manifold actuator using the second DC power supply when the control system is disconnected from the AC power supply; and
the control system is configured to power the valve manifold actuator to close the valve manifold in response to an input, the input selected from a group of inputs consisting of a predetermined time period, a reset signal, a mechanical release, and pressure/quantity of air released by the manifold.

29. (canceled)

30. The patient support apparatus according to claim 24, wherein the first DC power supply comprises a first onboard rechargeable DC power supply, wherein the second DC power supply comprises a second onboard rechargeable DC power supply.

31. (canceled)
